(19) United States
(12) Patent Application Publication
(10) Pub. No.: US 2010/0299217 A1
(43) Pub. Date: Nov. 25, 2010

(54) WARRANTY MANAGEMENT SYSTEM

(76) Inventor: Richard Hui, Coquitlam (CA)

Correspondence Address: CAMERON IP, SUITE 1401 - 1166 ALBERNI STREET, VANCOUVER, BC, V6E 3Z3, CA

(21) Appl. No.: 12/706,593

(22) Filed: Feb. 16, 2010

Related U.S. Application Data
(60) Provisional application No. 61/152,940, filed on Feb. 16, 2009.

(51) Int. Cl. G06Q 10/00; G06Q 30/00

(52) U.S. Cl. 705/23; 705/16; 705/302

(57) ABSTRACT

A warranty management system comprises a hardware device for inputting warranty information and a copy of a receipt. A network permits communication between the hardware device and a server. The server stores the warranty information and the copy of the receipt. The warranty management system also includes a means for verifying the authenticity of the warranty information and the related receipt. Some embodiments of the warranty management system may further include a means for comparing the failure rates of products and services.

### CROSS-REFERENCE TO RELATED APPLICATION

This application claims the benefit of provisional application 61/152,940 filed in the United States Patent and Trademark Office on Feb. 16, 2009, the disclosure of which is incorporated herein by reference and priority to which is claimed.

### BACKGROUND OF THE INVENTION

1. Field of the Invention

The present invention relates to a warranty management system and, in particular, to a third party warranty management system which allows for the tracking of a warranty and related receipts as well as verification of the authenticity of information contained therein.

2. Description of the Related Art

Most products and services come with some type of warranty. Yet, when products or services fail, it is common for the warranty to go unclaimed. Warrantees typically regard a defective product or service as a write off instead of claiming their warranty. In many cases this is due to the warrantee being unable to locate the warranty and/or related receipts, or being unable to keep track of all purchases and warranty expiration dates. Alternatively, the warrantee may not have followed the service requirements mandated by an extended warranty. It is accordingly desirable to have a system for managing and tracking a warranty and related receipts.

In manual warranty management systems, a warranty and related receipt are stored by a warrantee in a manual filing system or “shoe box style” filing system. When a product or service fails the warrantee mails a copy of the warranty and related receipts to the warrantor to claim the warranty. However, manual filing systems are difficult to maintain and oftentimes the warrantee is unable to locate the warranty and/or related receipts. To overcome this problem, some warranty management systems allow a warrantee to mail a warranty and related receipts to the warrantor for storage. However, this merely shifts the burden of maintaining the manual filing system to the warrantor. Manual warranty management systems are also limiting in that faded or otherwise damaged warranties or receipts can be difficult to authenticate and are subject to forgery.

Electronic warranty management systems allow a warrantee to email a warranty and related receipt to the warrantor for electronic or automated tracking. Electronic warranty management systems typically have a remote portal to allow for data entry by a warrantee. Alternatively, data entry may be done by a warrantor at a central location. This data entry process is subject to human error and dishonesty making it difficult to verify information prior to the warrantor honouring the warranty. There is also typically no means for tracking the transfer of a warranty. Finally, because electronic warranty management systems are generally managed by a single warrantor there is also no means for a warrantor to compare the performance of its products and services against those of its competitors. There is accordingly a need for an improved warranty management system.

### SUMMARY OF THE INVENTION

It is an object of the present invention to provide an improved third party warranty management system.

It is a further object of the present invention to provide a warranty management system which allows for the tracking of a warranty and related receipts as well as verification of the authenticity information contained therein.

It is still a further object of the present invention to provide a warranty management system which allows a warrantee to compare the failure, performance, service and quality rates of competing products and services; and allows a warrantor to compare the failure rates of its products and services against those of its competitors.

There is accordingly provided a warranty management system comprising a hardware device for inputting warranty information and an electronic copy of a related receipt. The hardware devices may be in the form of an e-commerce store mainframe computer or a brick and mortar store point of sales or service (POS) system. A network permits communication between the hardware device and a server. The server stores the warranty information and the electronic copy of the receipt. The warranty management system also includes a means for verifying the authenticity of the warranty information and the receipt. Some embodiments of the warranty management system may further include a means for comparing the failure rates of products and services covered under warranty by comparing user actions within the system against product models and manufacturer data.

In a first embodiment, the third party warranty management system allows warranty information to be inputted at the time of purchase. A POS hardware system for receives a unique warrantee identifier, purchase information, warranty information and generates a receipt. The POS hardware system may be located at a brick and mortar store or may include a mainframe computer of an e-commerce store. When the POS hardware system is located at a brick and mortar store, the purchase information will typically include at least one of a product barcode and a UPC, and the POS hardware system will include a scanner for scanning the product barcode or UPC. When the POS hardware system includes a mainframe computer of an e-commerce store, the third party warranty management system may further including a processor remote from the mainframe computer for inputting the unique warrantee identifier, the purchase information and the warranty information. The third party warranty management system will include a scanner for uploading the electronic copy of the receipt if the POS hardware system generates a paper receipt.

A network, preferably the Internet, permits communication between the POS hardware system and the third party server. A feed transmits the purchase information, the warranty information and the electronic copy of the receipt from the POS hardware system to the third party server. The third party server stores the purchase information, warranty information, and an electronic copy of the receipt. There is a means for verifying the authenticity of the purchase information and the electronic copy of the receipt and a means for determining a length of a warranty based on the purchase information and warranty information. The warranty management system may further include a means for embedding an authentication code into the electronic copy of the receipt. A supplemental feed may update at least one of the warranty information, the purchase information and the copy of the receipt. A data repository supported by the third party server for stores the purchase information, warranty information, and an electronic copy of the receipt. The data repository may include an online database which may be accessed by a system user using a processor provided with an application for retrieving HTTP documents.

The third party warranty management system may include a notification feed transmitted from the third party server to a remote processor to notify a warrantor that a warranty will expire. The notification feed may include an offer to extend the warranty. The third party warranty management system may further include a question and answer mechanism in which a question is sent to a system user based on the purchase information and warranty information associated with said system user, and an answer is returned to the third party server. A rating system may be generated based on the answers returned to the server and the purchase information.

In a second embodiment, the third party warranty management system allows warranty information related to a past purchase to be inputted. This embodiment of the third party warranty management system further comprises a device for manually inputting a unique warrantee identifier, purchase information, and warranty information. A scanner is electronically connected to the processor for uploading an electronic copy of a paper receipt. The unique warrantee identifier, purchase information, warranty information and electronic copy of the receipt are transmitted to the third party warranty management system which has the general features described above for the first embodiment thereof

Also provided is a method for tracking and managing a warranty. The method comprises the steps of:
inputting a unique warrantee identifier, purchase information, and warranty information;
generating a receipt and uploading an electronic copy of the receipt;
transmitting the purchase information, the warranty information and the electronic copy of the receipt to a third party server;
verifying the authenticity of the purchase information and the electronic copy of the receipt; and
determining a length of a warranty based on the purchase information and warranty information.

The method may further include step of embedding an authentication code into the electronic copy of the receipt. A warrantee may be notified that a warrantee is about to expire and offered an option to extend the warrant. A commission may be paid if the warrantee extends the warranty. A ranking system may be generated based on the purchase information and warranty information.

The warranty management system disclosed herein provides the advantage of allowing warrantees and warrantors to quickly and easily track a warranty and related receipt, while receiving third party verification as to the authenticity of the information contained therein. The warranty management system disclosed herein also provides the advantage of allowing failure rates of competitive products to be compared.

### BRIEF DESCRIPTION OF DRAWINGS

The invention will be more readily understood from the following description of preferred embodiments thereof given, by way of example only, with reference to the accompanying drawings, in which:

FIG. 1 is a schematic illustrating a distributed data processing system in which an improved warranty management system may be implemented;

FIG. 2 is schematic illustrating architecture of a processor of the data processing system of FIG. 1;

FIG. 3 is a schematic illustrating a first subsystem of the improved warranty management system;

FIG. 4 is a schematic illustrating a second subsystem of the improved warranty management system;

FIG. 5 is a schematic illustrating a third subsystem of the improved warranty management system;

FIG. 6 is a flowchart illustrating a process for verifying and authenticating purchase information and warranty information within the improved warranty management system;

FIG. 7 is a flowchart illustrating a process for notifying a warrantee of warranty expiration within the improved warranty management system;

FIG. 8 is a flowchart illustrating a process for transferring a warranty within the improved warranty management system;

FIG. 9 is a flowchart illustrating a process for transferring a warranty and hardware within the improved warranty management system;

FIG. 10 is a flowchart illustrating a process for generating a product or service ranking system within the improved warranty management system;

FIG. 11 is a flowchart illustrating another process for generating a product or service ranking system within the improved warranty management system;

FIG. 12 is a screenshot illustrating a web page displaying purchase information and warranty information stored on the improved warranty management system;

FIG. 13 is a screenshot illustrating a web page that may be used to input purchase information, warrantee identifier and upload a copy of a receipt to the improved warranty management system; and

FIG. 14 is another screenshot illustrating a web page that may be used to input purchase information, warrantee identifier and upload a copy of a receipt to the improved warranty management system.

### DESCRIPTION OF THE PREFERRED EMBODIMENTS

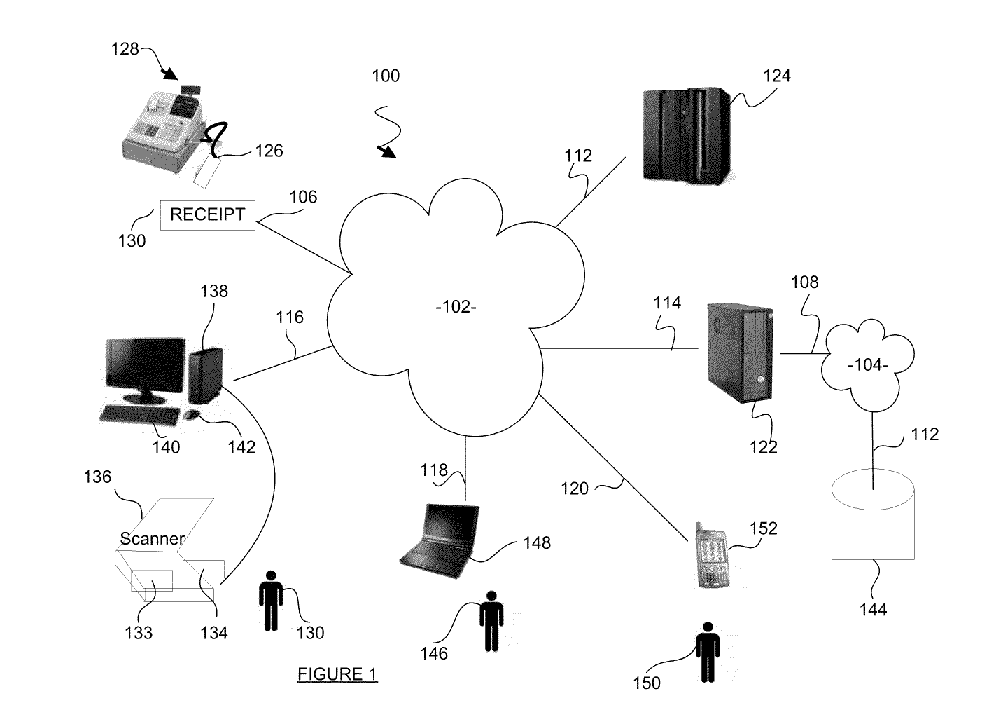

Referring to the drawings and first to FIG. 1 this shows a distributed data processing system 100. The distributed data processing system 100 is given by way of example only, and is typical of a data processing system in which an improved warranty management system may be implemented. The data processing system 100 includes networks 102 and 104 which provide communication links between various processors. The communications links may be permanent connections including, but not limited to, wires 106, 108 and 110 or fiber optic cables 112 and 114. The communication links may also be temporary connections including, but not limited to, connections made through telephone 116 or wireless communication 118 and 120. In the data processing system 100 one of the networks 102 is the Internet and the other one of the networks is an intranet such as a wide area network (WAN) or a local area network (LAN). It will be understood by a person skilled in the art that the data processing system 100 may further include additional networks and various different types of networks which have not been shown.

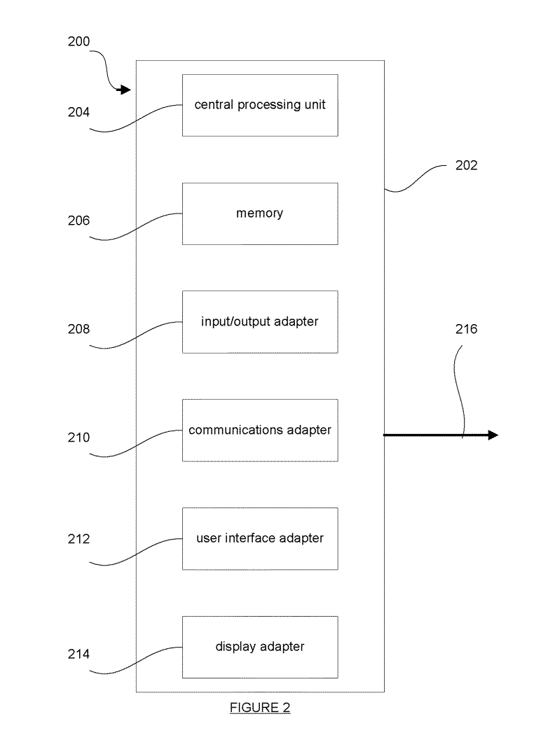

The data processing system 100 further includes a plurality of processors. FIG. 2 illustrates an exemplary architecture 200 of a processor in the data processing system 100. An internal bus system 202 interconnects a central processing unit (CPU) 204 with a memory 206, an input/output adapter 208, a communications adapter 210, a user interface adapter 212, and a display adapter 214. The memory 206 may include one or more types of random access memory (RAM) and read only memory (ROM). The memory 206 may also include one or more types of volatile and non-volatile memory. The input/output adapter 208 may support various input/output devices including, but not limited to, a disk unit, a printer, and a scanner. The communications adapter 210 may provide access to a communication link 216 such as a fiber optic cable which may connect the CPU 204 to the data processing system 100 of FIG. 1. The user interface adapter 212 may support various user interface devices, including but not limited to, a touch screen, a keyboard, and a mouse. The display adapter 214 may support various display devices such as a monitor. FIG. 2 is provided by way of example only and is in no way intended to imply architectural limitations to any processor in distributed data processing system 100 of FIG. 1. Furthermore, it will be understood by a person skilled in the art that the hardware of FIG. 2 may vary between processors.

Furthermore, in addition to being implemented on a variety of hardware platforms, the warranty management system may also be implemented on a variety of software platforms, i.e. the operating system used may vary between processors. For example, a server may run on a Linux® operating system, while a mainframe computer runs on an IBM z/OS® operating system and desktop computer runs on a Microsoft® operating system. Other processors in the distributed data processing system 100 may run on other operating systems. The processors in the distributed data processing system 100 may further support a typical browser application or another suitable application for retrieving HTTP documents in a variety formats. It will be understood by a person skilled in the art that the data processing system 100 may further include additional processors and various different types of processors which have not been shown.

In this example, referring back to FIG. 1, the data processing system 100 includes a third party server 122 and a mainframe computer 124. The server 122 supports the improved warranty management system. The mainframe computer 124 supports an e-commerce store. Purchase and warranty information is sent to the server 122 through a data transfer over the Internet 102 when a purchase is made at the e-commerce store. There is also a barcode or Universal Product Code (UPC) scanner 126 which is part of a brick and mortar store point of sale/service (POS) system 128. The scanner 126 is used to scan a UPC 130 to input purchase and warranty information into the POS system when a purchase is made at the brick and mortar store. The POS system 128 sends the purchase information and warranty information to the server 122 through a data transfer over the Internet 102. A warrantee 132 is also able to input and view purchase and warranty information send to the server 122. A paper copy of a receipt 134 and/or warranty 136 may be scanned into electronic form using a flatbed scanner 138 connected to a personal or desktop computer 140. Alternatively, the warrantee 132 may input warranty information through manual data entry using a keyboard 142 and mouse 144 connected to the desktop computer 140. The purchase and warranty information sent to the server 122 is stored in a data repository 146. The data repository 146 may be maintained on the third party server 122 or another suitable server. Information in the data repository 146 may be accessed and viewed by the warrantee 132 using the desktop computer 140, a warrantor 148 using a processor such as a laptop computer 150, or by another interested party 152 using a processor such as smart phone 154. The warrantee 132, warrantor 148 and interested party 152 are each considered a user of the system.

Service updates, records integration, and recall mechanism files related to the warranty can also be sent to the data repository 146 by the warrantee 132, warrantor 148, or interest party 152. This information may later be accessed by over the Internet 102 using a web based application. The warranty management system disclosed herein also communicates with the warrantee 132, warrantor 148, or interest party 152 over the Internet 102. The communication may be through a web based system such as email accessed at a desktop computer 140 or laptop computer 150, or by a push notification to a smart phone 154 or other suitable device. The data processing system 100 may also be used to establish a question and answer mechanism. In traditional scenarios, the question and answer system is executed by allowing one user to send a question to many general users. However, in the system disclosed herein a question is sent only to users based on the purchase information.

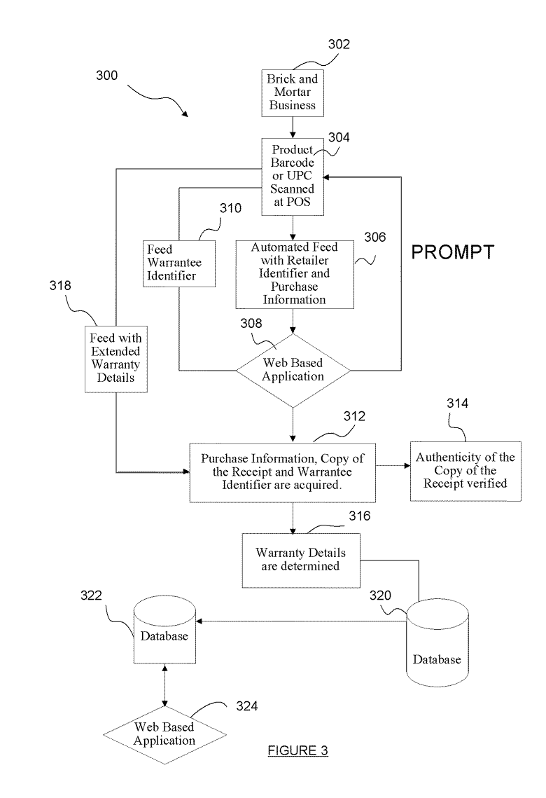

Referring now to FIG. 3, this shows a block diagram a subsystem 300 which tracks a warranty and related receipt for a product purchase made at a brick and mortar store 302. The product barcode or UPC code is scanned into the system 300 at the POS 304 to confirm the product date code and serial number. An automated feed 306 is then sent through a unique retailer identifier to a web based application 308. The automated feed provides the subsystem 300 with information to identify the product. The information may include a description of the product, make and model number, date of purchase, method of payment, product date code, purchase price, purchase location, stock keeping unit (SKU) as well as other information. This information is collectively known as the purchase information and will include information normally identified during a completion of a product purchase at a brick and mortar store. In other examples, the purchase information may be inputted through other means. Product date codes or serial numbers may be obtained through image recognition or image capture technology or be manually entered. Manual data entry is preferred in cases where a warranty covers a service and there is no product bar code or UPC code. The system can receive manually entered data by point-to-point data transfer.

After the web based application 308 receives the automated feed, the subsystem 300 prompts the store at the POS 304 to take an electronic image capture copy of the receipt or automatically upload an electronic copy of the receipt to web based application 308 or local application to be loaded later. Data may be extracted from the image capture by optical character recognition (OCR) technology. Copies of the receipt or other receipt details can be added or amended at a later date. The store 302 is also prompted to enter a unique warrantee identifier and password. This information is sent by a feed 310 to the web based application 308. The unique warrantee identifier may be a warrantee email address, membership number, phone number, or user name. The purchase information and the copy of the receipt together with the unique warrantee identifier and password are acquired by the subsystem 300 at block 312. The system associates the copy of the receipt with the purchase information. The subsystem 300 may also record a date/time/GPS (Global Position System) capture when the purchase information, copy of the receipt, and warrantee identifier are acquired.

The copy of a receipt received from the store 302 is authenticated by the system 300 as shown at block 314. Authentication of the copy of the receipt starts with the generation of the purchase information at the POS 304 when the sale is made at the store 302 as described above. The subsystem 300 will confirm and “freeze” the purchase information as the POS 304 transmits a true electronic copy of the receipt data. The system 300 embeds a unique authentication code into the copy of the receipt. The copy of the receipt will be available to a user and serve as an authenticated copy of the receipt provided with a unique authentication code in the form of a unique authentication number. The authentication number functions as an authentication key which identifies the receipt as original and unaltered.

The length of an automated warranty and other warranty details are determined by the system at block 316 based on the purchase information. Extended warranty details may be entered at the POS 304 and sent by a feed 318. This information is collectively known as the warranty information. The POS 304 is prompted by web based application 308 to manually enter the length of the warranty and other warranty details if automated warranty details are not available. The system can receive manually entered data by point-to-point data transfer. The system associates the warranty information the copy of the receipt and the purchase information.

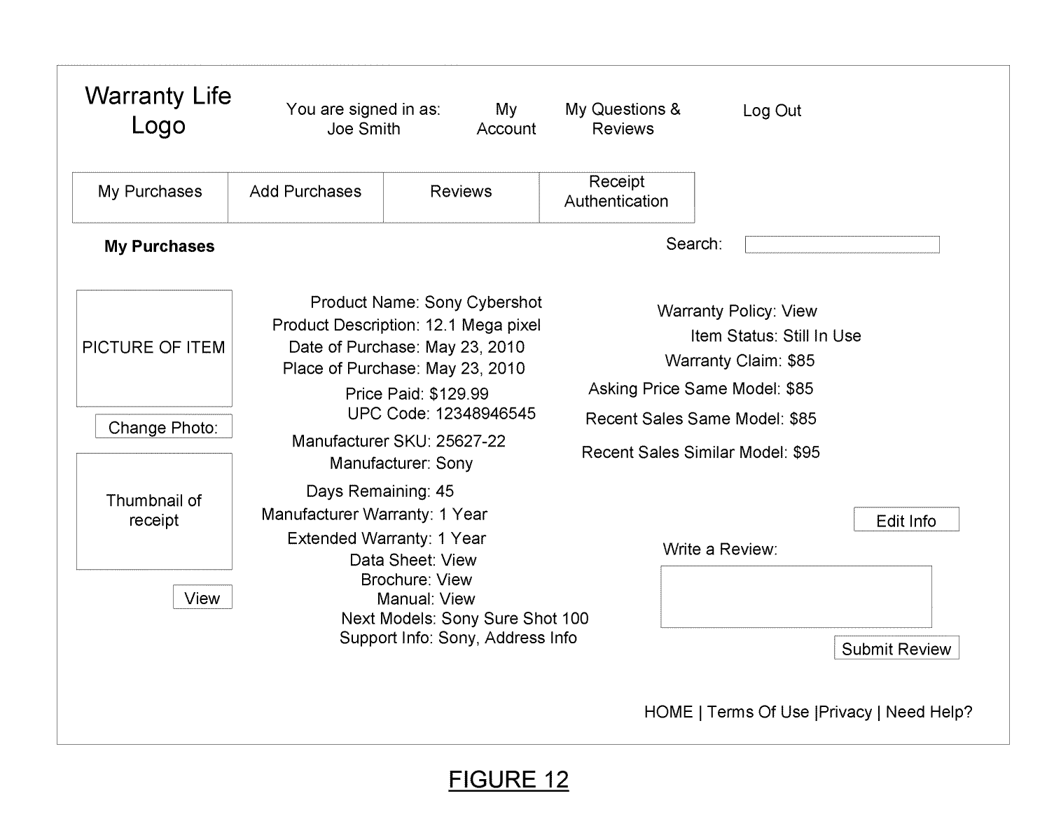

The purchase information and the associated copy of the receipt together with the associated warranty information are provided to a database 320 supported by a third party server for infinite storage and verification. The subsystem 300 also sends a copy of the receipt together with the verified purchase information and warranty information to an online or local database 322. This allows a user to search and manage the purchase information and warranty information via a web based application 324. For example, an interested party such as a manufacturer or repair/service provider may verify the authenticity of the copy of the receipt by returning to the web based subsystem 300 and entering the authentication code. The subsystem 300 will verify the authenticity of the copy of the receipt associated with the authentication code and the purchase information associated therewith. This helps prevent receipt fraud. FIG. 12 shows an exemplar screenshot of a web page displaying purchase information and warranty information stored on the databases.

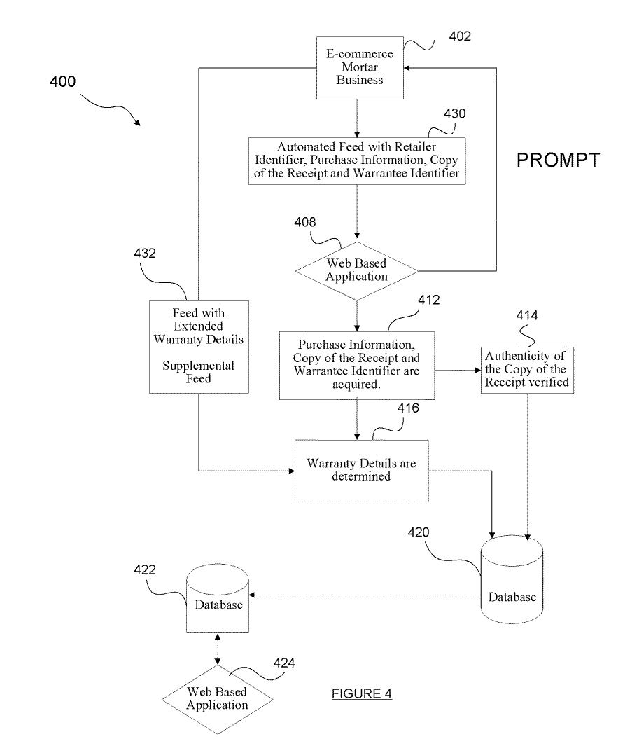

Referring now to FIG. 4, this shows a block diagram of a subsystem 400 which tracks a warranty and related receipt for a purchase made at an e-commerce store 402. In FIG. 4 like elements have been given like reference numerals as in FIG. 3 with the exception that the reference numerals are in the 400 series as opposed to the 300 series, i.e. the web base application is given reference numeral 308 in FIG. 3 and reference numeral 408 in FIG. 4. Similarly the database has been given reference numeral 320 in FIG. 1 and reference numeral 420 in FIG. 4. The warranty management system 400 tracks a warranty and a related receipt for a purchase at the e-commerce business 402 in a similar manner as the subsystem 300, shown in FIG. 3, tracks a purchase at the brick and mortar business 302. However, a single automated feed 430 provides the system with the retailer identifier, purchase information, electronic copy of the receipt and warrantee identifier. The subsystem 400 also allows extended warranty details to be entered at the e-commerce retailer 402, typically from a remote workstation, and sent by a supplemental feed 432. The supplemental feed 432 may also include any information not sent in the automated feed.

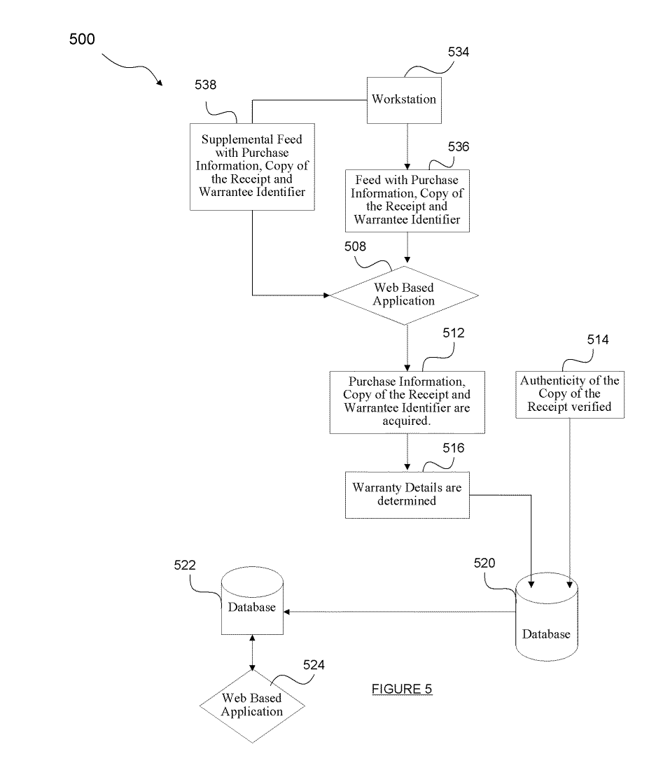

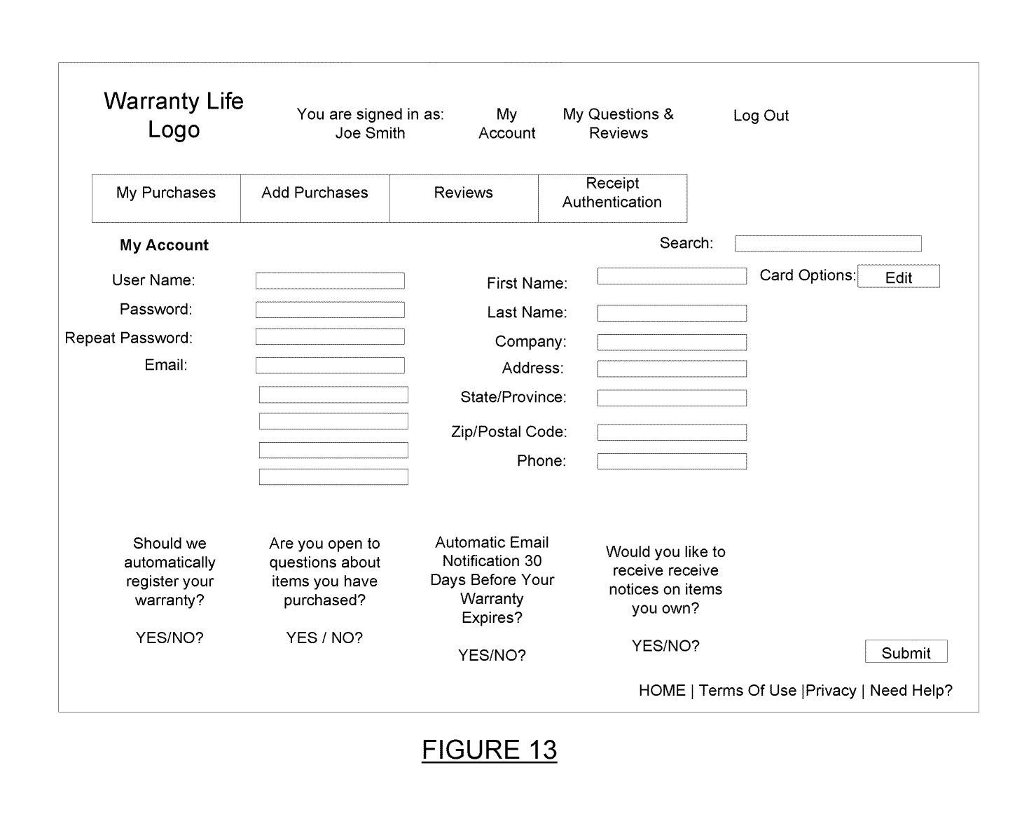

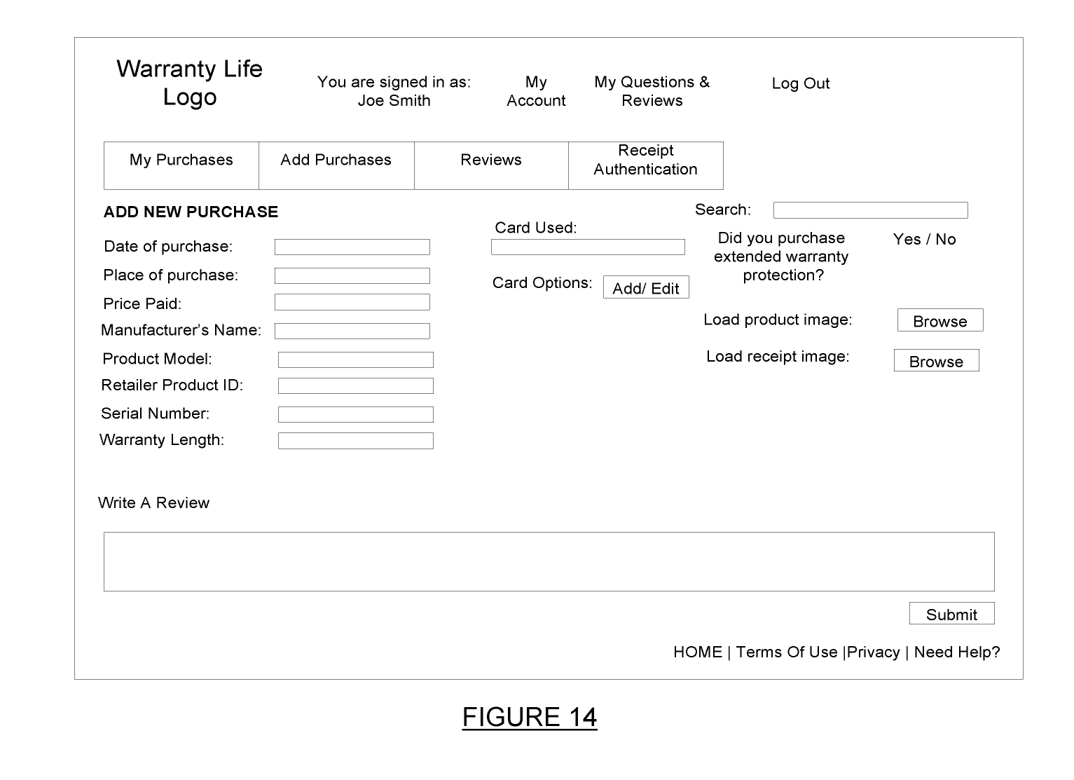

Referring now to FIG. 5, this shows a block diagram of a subsystem 500 which tracks a warranty and related receipt for past purchases. In FIG. 5 like elements have been given like reference numerals as in FIG. 3 with the exception that the reference numerals are in the 500 series as opposed to the 300 series, i.e. the web based application is given reference numeral 308 in FIG. 3 and reference numeral 508 in FIG. 5. Similarly the database has been given reference numeral 520 in FIG. 1 and reference numeral 520 in FIG. 5. The subsystem 500 tracks a warranty and a related receipt for the past purchase in a similar manner as the subsystem 300, shown in FIG. 3, manages a purchase at the brick and mortar store 302. However, a user at a work station 534 manually inputs the purchase information, warrantee information and uploads a copy of the receipt and warrantee identifier. FIGS. 13 and 14 show screenshots of web pages that may be used to input the purchase information, warrantee identifier and upload a copy of the receipt. A retailer identifier is not required in this case. Referring back to FIG. 5, a single feed 536 provides the system 500 with the purchase information, electronic copy of the receipt, warrantee identifier and warranty information. The web based application will prompt the user at the work station 534 to initiate a supplemental feed 538 if any information required to determine the warranty details is missing.

It will be understood by a person skilled in the art that the subsystems 300, 400 and 500 may be linked in the improved warranty management system disclosed herein.

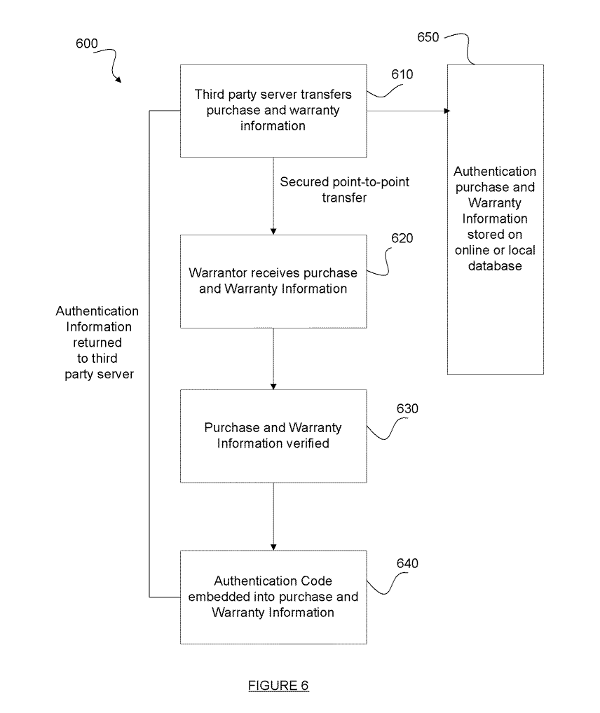

The copy of the receipt, product information and warranty information stored in the database supported by the third party server can also be verified by a warrantor. FIG. 6 shows a process 600 in which the copy of the receipt, purchase information and warranty information are verified. The copy of the receipt, purchase information and warranty information are sent from a third party server as shown at block 610 by a secured point-to-point transfer that is received by the warrantor at block 620. The warrantor may be a manufacturer, service provider, or insurer. The copy of the receipt, purchase information and warranty information are verified and authenticated by the warrantor using commercially available or proprietary means at block 630. In this example, the warrantor authenticates the copy of the receipt, purchase information and warranty information by embedding an authentication code in the copy of the receipt and information as shown at block 640. Once the copy of the receipt, purchase information and warranty information are verified and authenticated by the warrantor, the authenticated copy of the copy of the receipt, purchase information and warranty information is sent back to the third party server. In this example, the authenticated copy of the copy of the receipt, purchase information and warranty information is sent via an encrypted code or embedded file. A copy of the receipt with an embedded code or encrypted file is then sent from the third party server to the online or local database as indicated by block 650. This is particularly useful in the case of past purchases to ensure that a receipt was not altered.

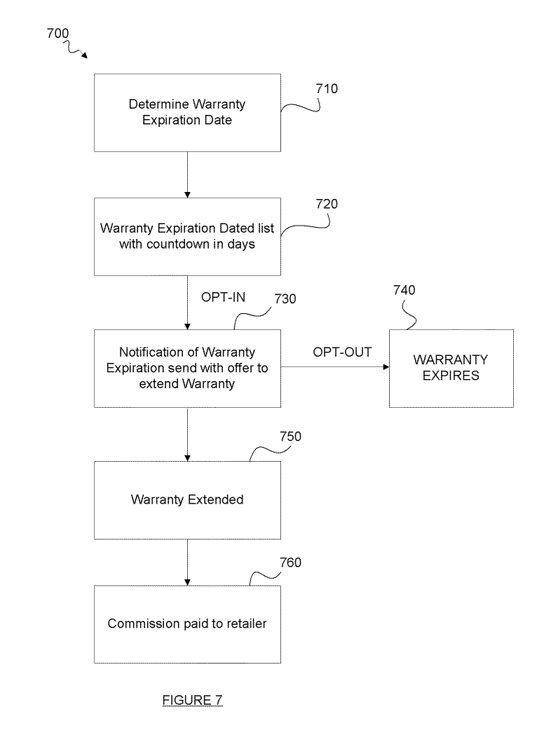

The warranty management system disclosed herein provides a countdown for the expiration of a manufacturer warranty or extended warranty. FIG. 7 shows a process 700 for determining the expiration of a warranty. The system determines the warranty expiration date at block 710. The warranty expiration date is listed with a countdown in days at block 720. This information may be accessed using a web based application. However, a warrantee also can opt-in to receive notification of an upcoming warranty expiration. The notification is sent with an offer to extend a manufacturer warranty or further extend an extended warranty as shown at block 730. The warrantee can opt-out of receiving notifications in which case the warranty will expire as shown at block 740. Should the warrantee decide to extend the warranty as shown at block 750, commissions may be paid to the original retailer if the warrantee was referred to the system by the retailer as shown at block 760.

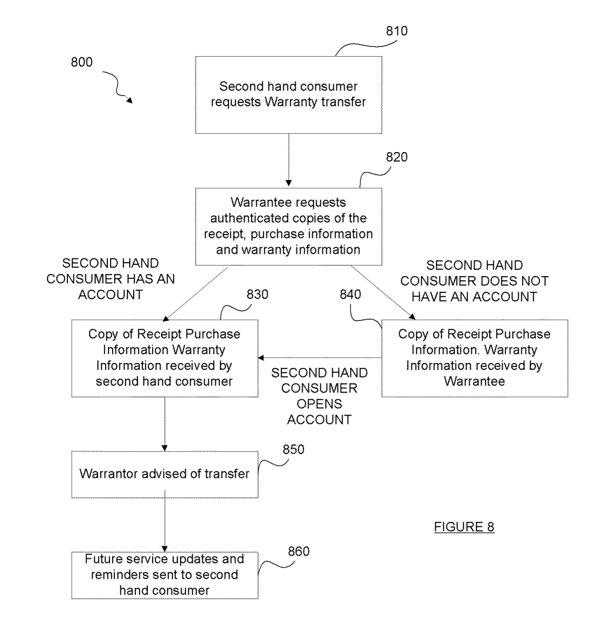

The warranty management system disclosed herein also allows a warranty to be transferred if a purchase is resold prior to the expiration of a warranty. FIG. 8 shows a routine 800 for transferring a warranty from a warrantee to a second hand consumer. The second hand consumer requests that the warranty be transfer at block 810. In turn, as indicated at block 820, the warrantee requests authenticated copies of the receipt, purchase information and warranty information. The authenticated copies of the receipt, purchase information and warranty information may be sent directly to the second hand consumer as shown by block 830 if the second hand consumer has an account on the system. Alternatively the copies of the receipt, purchase information, and warranty information may be sent to the warrantee as shown at block 840. The warrantee forwards the same to the second hand consumer after the second hand consumer opens an account on the system. The system also advises the warrantor of the warranty transfer as shown at block 850. The warrantor forwards future service updates or reminders to the second hand consumer as indicated by block 860.

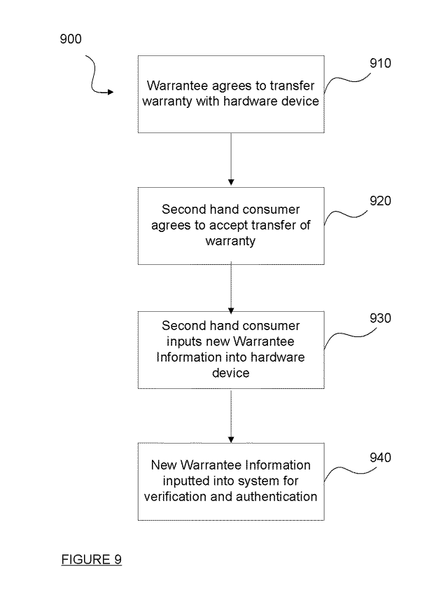

A warranty may also be transferred with a hardware device within the system. FIG. 9 discloses a routine 900 for transferring a warranty coupled to a hardware device such as a smart phone. In such cases the unique warrantee identifier would be the phone number and the warranty would accordingly follow the smart phone. When the smart phone is resold to a second hand consumer the warrantee can agree to transfer the warranty as shown indicated at block 910. If the second hand consumer agrees to accept the transfer of the warranty, as shown at block 920, this decision is communicated to the system using the smart phone number as the unique identifier. The second hand consumer also inputs their information, i.e. the new warrantee information, into the smart phone as shown at block 930. The new warrantee information is inputted into the system for verification and authentication as shown at block 940. The second hand consumer consequently becomes a user of the system through acquisition of the smart phone or another device designed to communicate remotely with the system.

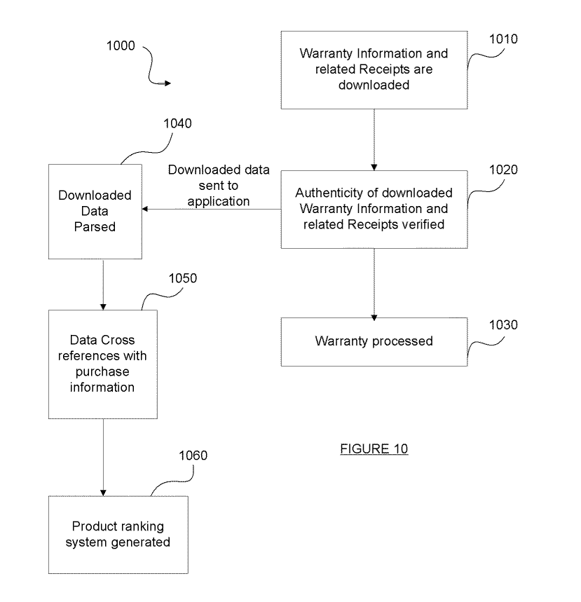

FIG. 10 shows a process 1000 for claiming a warranty. When a warranty is claimed, a copy of the warranty information and related receipts with embedded authentication codes or encrypted files are downloaded as shown at block 1010. The embedded authentication code or encrypted files are used to verify the authenticity of the downloaded warranty information and related receipt as shown at block 1020. The downloaded warranty information and related receipts are forwarded to the warrantor for the claim to be processed as shown at block 1030. The downloaded warranty information and related receipts are also sent to an application 1040 which parses data to be used in a product review system. The parsed data is sent to a data repository where it is cross-referenced with the product information as shown at block 1050. A comparison and analysis based on the ratio of warranty claims to sales is performed based on product details, questions, claims and service related issues as identified by the system. This analysis is made available and may be used to generating a product or service ranking as shown at block 1060.

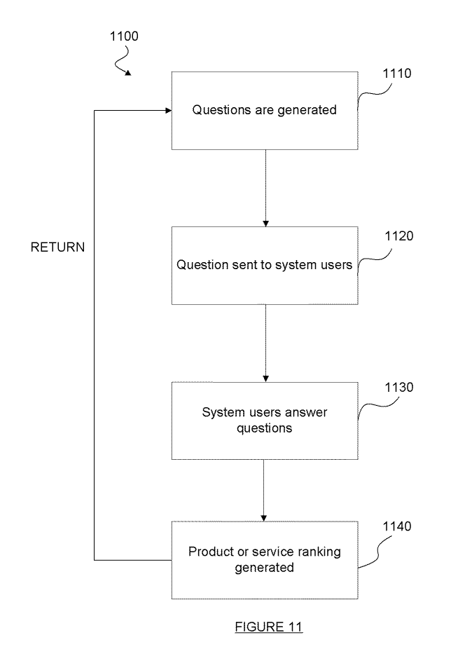

FIG. 11 shows an alternative process 1100 for generating a product or service ranking. Questions are generated as shown at block 1110. The questions are sent to system users based on the purchase information associated with said system user as shown at block 1120. The system user inputs answers to the questions as shown at block 1130. The answers are uploaded and may be used to generate future questions or a product or service ranking as shown at block 1140. This allows for a fluid product or service ranking based on input from system users.

The improved warranty management system disclosed herein provides the advantage of allowing users to upload warranty information and purchase information. This information can then be tracked quickly and efficiently for budget purposes or in case of a product or service failure, or product return. The existence of a warranty can be quickly determined and a copy of the receipt readily retrieved. The system also allows users to safely manage warranty information for its intended use and streamline warranty claim processing.

The warranty system can provide functions such as:
organizing data by category or tags for quick view;
organizing data by oldest date or expiry date to determine whether the warranty has expired;
providing automated access to manuals and datasheets thereby eliminating the need for warrantors to provide printed manuals with troubleshooting pages specific to products;
providing warrantors with reduced support issues and providing additional service to the warrantees;
providing contact details and warranty process for easy access;
providing a list of local service providers for a warranty or out of warranty support;
providing automated email bulletins when service requirements and/or warranty expiration are approaching to advise warrantees and warrantors of warranty status; and
providing a mechanism for warranty reporting.

Information stored in the warranty management system may be used to analyze and compare sales rates against return or support rates to identify problem areas. Public reports can be generated for the manufacturer or public in the form of reviews. Manufacturers may use these reports to improve products. Consumers may use the reports to rate product reliability when making purchasing decisions. The data may be collected by manufacturers, service providers, wholesalers, retailers, consumers, and other interested parties.

A warrantee will have the ability to print an authenticated copy of a receipt using a unique identifier as determined by the warranty management system. The warranty management system also allows downloading of information for importation into other accounting programs. Budget trackers will find this a quick and efficient method of tracking expenses. The transfer of a warranty can be done through the third party verification system which will help facilitate buyer confidence and efficient transfer of the warranted item.

Retailers can use the warranty management system to induce consumers to purchase additional extended warranties as it solves the problem of warranty management and tracking. Users of the warranty management system will have greater confidence in buying products as they can track warranties and sell them if need be. Users will save time and enjoy financial benefit and peace of mind knowing they are covered.

The warranty management system also provides a convenient web based portal that will allow a venue for sorting and retrieval of receipts for warranty claim processing. The web based portal allows for retrieval of direct information on a specific warranty, manuals, support, service locations or other supporting information associated with product entries. The warranty management system can also provide manufacturers with integrated warranty or service information, allowing for more efficient, automated service including recalls. When a warranty needs to be claimed, the warrantee can be presented with automated return to input information based on his or her location and product, thus saving time for them needing to search, call and seek out the warranty process.

Some warranties come with the feature of service events. The warranty management system allows warrantors to integrate these service events into a reminder system for the warrantee. In the event of a secondary sale, the warranty can be confirmed by the aftermarket consumer and then transferred via the authentication system.

It will be understood by a person skilled in the art that many of the details provided above are by way of example only, and are not intended to limit the scope of the invention which is to be determined with reference to following claims.

What is claimed is:

1. A third party warranty management system comprising:
a POS hardware system for receiving a unique warrantee identifier, purchase information, warranty information and generating a receipt;
a server for storing the purchase information, warranty information, and an electronic copy of the receipt, the server being the server of a third-party excluding a warrantor and warrantee;
a network for permitting communication between the POS hardware system and the server;
a feed for transmitting the purchase information, the warranty information and the electronic copy of the receipt from the POS hardware system to the third party server;
a means for verifying the authenticity of the purchase information and the electronic copy of the receipt; and
a means for determining a length of a warranty based on the purchase information and warranty information.

2. The warranty management system as claimed in claim 1 wherein the purchase information includes at least one of a product barcode a UPC and an RFID, the POS hardware system including a scanner for scanning the product barcode or UPC.

3. The warranty management system as claimed in claim 1 wherein the POS hardware system generates a paper receipt and includes a scanner for uploading the electronic copy of the receipt.

4. The warranty management system as claimed in claim 1 wherein the POS hardware system is located at a brick and mortar store.

5. The warranty management system as claimed in claim 1 wherein the POS hardware system includes a mainframe computer of an e-commerce store.

6. The warranty management system as claimed in claim 5 further including a device remote from the mainframe computer for inputting the unique warrantee identifier, the purchase information and the warranty information.

7. The warranty management system as claimed in claim 1 further including a supplemental feed for updating at least one of the warranty information, the purchase information and the copy of the receipt.

8. The warranty management system as claimed in claim 1 further including a data repository supported by the server for storing the purchase information, warranty information, and an electronic copy of the receipt.

9. The warranty management system as claimed in claim 8 wherein the data repository includes an online database which may be accessed by a system user using a processor provided with an application for retrieving HTTP documents.

10. The warranty management system as claimed in claim 1 further including a means for embedding an authentication code into the electronic copy of the receipt.

11. The warranty management system as claimed in claim 1 further including a notification feed transmitted from the third party server to a remote processor to notify a warrantor that a warranty will expire.

12. The warranty management system as claimed in claim 11 wherein the notification feed includes an offer to extend the warranty.

13. The warranty management system as claimed in claim 1 further including a question and answer mechanism wherein a question is sent to a system user based on the purchase information and warranty information associated with said system user and an answer is returned to the third party server.

14. The warrantee system as claimed in claim 13 further including a means for generating a rating system based on the answer returned to the server and the purchase information.

15. A third party warranty management system comprising:
a device for manually inputting a unique warrantee identifier, purchase information, and warranty information;
a scanner electronically connected to the device for uploading an electronic copy of a paper receipt;
a third party server for storing the purchase information, warranty information, and an electronic copy of the receipt;
a network permitting communication between the device and the server;
a feed transmitting the purchase information, the warranty information and the electronic copy of the receipt from the device to the third party server;
a means for verifying the authenticity of the purchase information and the electronic copy of the receipt; and
a means for determining a length of a warranty based on the purchase information and warranty information.

16. The warranty management system as claimed in claim 1 further including a means for embedding an authentication code into the electronic copy of the receipt.

17. A method for tracking and managing a warranty includes the steps of:
inputting a unique warrantee identifier, purchase information, and warranty information;
generating a receipt and uploading an electronic copy of the receipt;
transmitting the purchase information, the warranty information and the electronic copy of the receipt to a third party server;
verifying the authenticity of the purchase information and the electronic copy of the receipt; and
determining a length of a warranty based on the purchase information and warranty information.

18. The method as claimed in claim 17 further including the step of embedding an authentication code into the electronic copy of the receipt.

19. The method as claimed in claim 17 further including the steps:
notifying a warrantee that a warranty is about to expire;
offering the warrantee an option to extend the warrant: and
paying a commission if the warrantee extends the warranty.

20. The method as claimed in claim 17 further including the step of generating a ranking system based on the purchase information and warranty information.
